(19) United States
(12) Patent Application Publication
(10) Pub. No.: US 2014/0271098 A1
(43) Pub. Date: Sep. 18, 2014

(54) Vertical Structure Bracket Mount Apparatus and System

(71) Applicant: XELA INNOVATIONS, LLC, Glendale, WI (US)

(72) Inventors: Todd J. Muderlak, Whitefish Bay, WI (US); Kenneth J. Muderlak, Milwaukee, WI (US)

(73) Assignee: Xela Innovations, LLC, Glendale, WI (US)

(21) Appl. No.: 13/831,370

(22) Filed: Mar. 14, 2013

(51) Int. Cl. B65F 1/14

(52) U.S. Cl. CPC B65F 1/1421
USPC 414/808; 248/299.1; 220/478

(57) ABSTRACT

A bracket mount for a disposal bin includes a vertical support plate for engaging a vertical structure, such as a wall or washroom partition; a bin plate for engaging the disposal bin, wherein the bin plate and the vertical support plate are pivotally engaged; and a cover stilt for supporting the cover the disposal bin in an opened position. The bracket mount may be provided as part of a container assembly including a bin and a cover, wherein when the bin plate with the bin attached thereto is positioned proximal to the vertical support plate, the cover is pivotal to cover and uncover the open end of the bin, and when the bin plate with the bin attached thereto is pivoted outwardly from the vertical support plate, the cover stilt is pivotable outwardly from the vertical support plate to support the cover in an open position relative to the bin.

### FIELD

The present disclosure relates to vertical structure brackets and mounting systems, and more specifically to a wall bracket system for use with a hygiene product disposal unit or garbage receptacle.

### BACKGROUND

Hygiene product disposal units receive and temporarily house personal hygiene products and other discarded products, such as tampons, syringes, diapers, etc. Most commonly, such disposal units reside in public bathrooms to provide a sanitary receptacle that houses used feminine hygiene products, syringes or diapers. Such units usually include a storage chamber and a cover. When servicing the units, the cover must be propped up for individuals to reach in the bin and retrieve the waste product, such as diapers, feminine tissue, syringes, etc. all with feces, blood, sweat, etc., from the vertically mounted unit. Not only is reaching into a vertically-mounted bin cumbersome, but the bin and cover are often contaminated with the waste product stored in the bin.

It is desirable to provide a system for mounting hygiene product disposal units which allows safe and easy access to the unit contents for removal of debris (whether in liners/bags or not) and removal of all parts from the vertical structure to repair, clean or disinfect.

### BRIEF SUMMARY

In at least one embodiment, a bracket mount for a disposal bin is provided that includes a vertical support plate for engaging a vertical structure, such as a wall or washroom partition; a bin plate for engaging the disposal bin, wherein the bin plate and the vertical support plate are pivotally engaged; and a cover stilt for supporting the cover the disposal bin in an opened position.

In at least another embodiment, a container assembly is provided that includes the bracket mount in combination with a bin and a cover, wherein when the bin plate with the bin attached thereto is positioned proximal to the vertical support plate, the cover is pivotal to cover and uncover the open end of the bin, and when the bin plate with the bin attached thereto is pivoted outwardly from the vertical support plate, the cover stilt is pivotable outwardly from the vertical support plate to support the cover in an open position relative to the bin.

In at least another embodiment, a method of emptying a disposal bin (with or without debris in liners/bags) is provided that includes pivoting a cover upward from the bin to an open position; pivoting a bin having an open end outwardly, relative to a vertical structure, from a vertical support plate; pivoting a cover stilt outward, relative to the vertical structure, from the vertical support plate; supporting the cover in the open position using the cover stilt; exposing the open end of the bin; and removing the contents of the bin.

In at least another embodiment, a method of removing a disposal bin is provided that includes pivoting the bin to an open or pivoted position and sliding the bin off of a bin plate. In at least another embodiment, a method of removing a disposal bin cover is provided that includes pivoting the cover to an open position and removing it from a wall plate. By quickly accessing and removing the individual components of a disposal bin (for example, the bin and cover), disposal bins may be easily removed for repairing or cleaning and disinfecting and replaced.

Other embodiments, aspects, features, objectives and advantages of the hygiene product disposal apparatus and method of use will be understood and appreciated upon a full reading of the detailed description and the claims that follow.

### BRIEF DESCRIPTION OF THE DRAWINGS

Embodiments of the disposal bin bracket mount and method of use are disclosed with reference to the accompanying drawings and are for illustrative purposes only. The bracket mount and method of use is not limited in its application to the details of construction or the arrangement of the components illustrated in the drawings. The bracket mount and method of use is capable of other embodiments or of being practiced or carried out in other various ways.

In the drawings:

FIG. 1 illustrates an exploded view of a bracket mount apparatus;

FIG. 2 illustrates a back view of the apparatus;

FIG. 3 illustrates a front view of the apparatus;

FIG. 4 illustrates a side view of the apparatus mounted to a wall;

FIG. 5 illustrates a side view of the apparatus with a hygiene product disposal bin partially mounted;

FIG. 6 illustrates a side view of the apparatus with hygiene product disposal bin fully mounted and in pivotal position;

FIG. 7 illustrates a side view of the apparatus with hygiene product disposal bin fully mounted in secured position;

FIG. 8 illustrates a cross-sectional side view of the apparatus as shown in FIG. 7 taken at a central region along the bin;

FIG. 9 illustrates a cross-sectional side view of the apparatus similar to that of FIG. 8, but with a taller hygiene product disposal bin;

FIG. 10 illustrates a side view of the apparatus with hygiene product disposal bin in pivotal position and the cover open;

FIG. 11 illustrates a cross-sectional side view of the apparatus as illustrated in FIG. 10;

FIG. 12 illustrates a side view of the apparatus with a liner in the hygiene product disposal bin; and

FIGS. 13 and 14 illustrate a side view of the apparatus similar to that of FIG. 12, but with the liner partially removed.

### DETAILED DESCRIPTION

Referring to FIG. 1, illustrated is an exploded view of an exemplary bracket mount apparatus 90 including vertical support plate 20, bin plate 30 and cover stilt 10. In the exemplary embodiment provided, bin plate 30 engages bin 200 through engaging structures 38 and 208 provided on bin plate 30 and bin 200, respectively. In further exemplary embodiments, bin plate 30 may be designed to engage bin 200 through other means known in the art, including, for example, but not limited to, clasps, clips, braces, friction-fit components, and combinations thereof. In still further exemplary embodiments, bin plate 30 may be designed to retrofit into existing hygiene product disposal bins.

As illustrated in FIG. 1, bin plate 30 includes male engaging structures 38 which slidingly engage female engaging structures 208 on bin 200. However, in further embodiments, engaging structures 38, 208 may be any corresponding engaging structures known in the art.

Vertical support plate 20 is designed to attach to a wall or other vertical structure through any means known in the art (e.g., screws) and includes bin connection structures 28 which engage and secure bin 200 when in its secured position (FIG. 7). Vertical support plate 20 and bin plate 30 pivotally connect at pivotal connection structures 35a, 35b. In the view shown in FIG. 1, a single pivotal connection structure 35a, 35b is shown for each of vertical support plate 20 and bin plate 30; however, it should be understood that pivotal connection structures 35a, 35b occur in pairs such that pivotal connection structure 35a shown on bin plate 30 engages a corresponding pivotal connection structure 35b (not shown) on vertical support plate 20 and pivotal connection structure 35b shown on vertical support plate 20 engaging a corresponding pivotal connection structure 35a (not shown) on bin plate 30.

In the exemplary embodiment shown, pivotal connection structures 35a, 35b are pegs on bin plate 30 with corresponding recesses on vertical support plate 20. However, in further exemplary embodiments, bin plate 30 and vertical support plate 20 may be pivotally connected through any means known in the art, including, for example, hinges.

Also shown in FIG. 1 is cover stilt 10 and lock access 212 and locking mechanism 202. Cover stilt 10 secures to vertical support plate 20 and props cover 210 open when bin 200 is in its pivotal position. Locking mechanism 202 secures bin 200 to cover 210 when bin 200 and cover 210 are assembled and secured to vertical support plate 20. Lock access 212 provides a way to release locking mechanism 202, such as with a key or other similar structure. In the exemplary embodiment shown in FIG. 1, locking mechanism 202 is a living hinge which engages cover 210 when cover 210 and bin 200 are in their secured position. The living hinge may be released (the cover 210 and bin 200) unlocked by pushing against the living hinge with a key or other structure. Other locking mechanisms and structures are known in the art and may be used to secure bin 200 and cover 210. For example, traditional key-type locks may be used.

Referring to FIGS. 2 and 3, illustrated are a back and front view of an exemplary bracket apparatus 90. Vertical support plate 20 and bin plate 30 are pivotally engaged with cover stilt 10 centrally positioned on vertical support plate 20. Cover stilt 10 is pivotally connected to vertical support plate 20. In further exemplary embodiments, cover stilt 10 may be positioned at any point on vertical support plate 20 in order to support cover 210.

FIG. 4 illustrates a side view of the apparatus 90 mounted to a wall 220. Vertical support plate 20 with cover stilt 10 is shown secured to wall 220 with bin plate 30 in its pivotal position. FIG. 5 illustrates a side view of the apparatus 90 with a disposal bin 200 partially mounted on bin plate 30. As illustrated, bin 200 is sliding onto bin plate 30, with engaging structures 38 engaging the channels 208 of bin 200. Bin 200 is slid onto bin plate 30 until bin 200 is fully engaged, as shown in FIG. 6.

While in the exemplary embodiments shown, apparatus 90 is described as mounted to a wall, it is to be understood that apparatus 90 may be mounted to any permanent or temporary vertical structure, including, but not limited to, walls, stalls, temporary or permanent partitions, doors, and other vertical substrates. As used herein, the term “vertical” may be used to refer to structures which are vertical, substantially vertical, or otherwise not perpendicular to the force of gravity.

FIGS. 5 and 6 also illustrate the ease with which bin 200 and/or cover 210 may be removed and replaced. To remove bin 200 from the apparatus 90 (such as for cleaning or repair), bin 200 may be slid from bin plate 30 and engaging structures 38 and 208 are disengaged. Similarly, cover 210 may be disengaged from vertical support plate 20.

FIG. 7 illustrates a side view of the apparatus 90 with bin 200 fully mounted in its secured position. In secured position, bin 200 engages bin connection structures 28 of vertical support plate 20 to remain secured in an upright vertical position for use. FIG. 8 illustrates a cross-sectional side view of the apparatus as illustrated in FIG. 7.

In some embodiments (as illustrated in FIG. 1), bin 200 and cover 210 may lock together when bin 200 is its secured position with apparatus 90. Locking bin 200 and cover 210 together may prevent theft or tampering with bin 200, cover 210 and/or apparatus 90. In such embodiments, in order to pivot bin 200 or cover 210 relative to vertical support plate 20, the bin 200 and cover 210 will need to be unlocked.

While in the exemplary embodiments shown, bin 200 is shown as a smaller disposal bin, such as those found in public restroom stalls, apparatus 90 may also be used with larger disposal bins 200, such as illustrated in FIG. 9. The configuration of slidingly-engaging structures 38 allows a bin of any size to be easily installed on or removed from apparatus 90. Similarly, cover stilt 10 allows for quick installation or removal of a cover on apparatus 90.

Referring to FIG. 10, illustrated is a side view of the apparatus 90 with disposal bin 200 in pivotal position and the cover 210 open. Cover stilt 10 is shown supporting cover 210 in its open position, while bin 200 is pivoted away from wall 220 to allow easy access to the contents of bin during servicing. Bin 200 remains secured to bin plate 30 during pivoting, and bin plate 30 pivots away from vertical support plate 20 with bin 200. FIG. 11 illustrates a cross-section of the apparatus 90 as shown in FIG. 10 with bin 200 in pivotal position.

In the exemplary embodiments described, the cover 210 is described as propped away from vertical support plate 20 by pivoting cover stilt 10 into position to support cover 210. It is to be understood that the pivoting of cover stilt 10 may be manual (i.e., the cover stilt 10 may be physically manipulated by a person) or the cover stilt 10 may be weighted, counterbalanced or otherwise configured to fall forward or lift from vertical support plate 20. Cover stilt 10 may also be actuated by a spring or other similar structure to push cover stilt 10 into position upon the pivoting of cover 210. Preferably, cover stilt 10 is weighted such that gravity forces cover stilt 10 into a proper position to support cover 210 when cover 210 is pivoted.

FIG. 12 illustrates a side view of the apparatus 90 similar to the view illustrated in FIG. 10, but with a liner 215 in the disposal bin 200. FIGS. 13 and 14 illustrate a side view of the apparatus 90 similar to that of FIG. 12, but with the liner 215 partially removed to show the ease of access to bin contents.

As can be seen in the described embodiments, when the bin plate 30 with the bin 200 attached thereto is positioned proximal to the vertical support plate, the cover 210 is pivotal to cover and uncover the open end of the bin 200, and when the bin plate 30 with the bin 200 is pivoted outwardly from the vertical support plate 20, the cover stilt 10 is pivotable outwardly from the vertical support plate 20 to support the cover 210 in an open position relative to the bin 200. With both the bin 200 and the cover 210 pivoted away from a wall 220 or other vertical structure, it becomes easier to access the contents of the bin 200. When the bin 200 is emptied, the bin 200 is pivoted back to the vertical support plate 20 and engages the bin connection structures 28 to secure to vertical support plate 20. The cover stilt 10 is then pivoted back toward vertical support plate 20 along with cover 210.

Disposal bins and covers may also be easily replaced using bracket mount apparatus 90 by sliding a used or broken bin off engaging structures 38 of bin plate 30 and sliding a new bin on engaging structures 38.

It is specifically intended that the hygiene product disposal apparatus and method of use not be limited to the embodiments and illustrations contained herein, but include modified forms of those embodiments including portions of the embodiments and combinations of elements of different embodiments as come within the scope of the following claims.

We claim:

1. A bracket mount for a disposal bin having an open end and a cover, comprising:
a vertical support plate configured to releasably engage the bin;
a bin plate pivotally connected to the vertical support plate and having a structure for releasably securing the bin; and
a cover stilt pivotally connected to the vertical support plate and configured to support the cover of the bin in an open position relative to the bin opening when the bin is in a pivotal position relative to the vertical support plate.

2. The bracket mount of claim 1, wherein the structure for releasably securing the bin is at least one engaging structure.

3. The bracket mount of claim 1, wherein the at least one engaging structure is a male mount component.

4. The bracket mount of claim 1, wherein the bin plate is pivotally connected to the vertical support plate using at least one pivotal connection structure.

5. The bracket mount of claim 4, wherein the pivotal connection structure is at least one pin connected to the bin plate and at least one recess corresponding to the pin on the vertical support plate.

6. The bracket mount of claim 1, mounted on a vertical substrate.

7. The bracket mount of claim 1 wherein the vertical support plate includes at least one bin connection structures for releasably securing the bin.

8. The bracket mount of claim 1 wherein the cover stilt is weighted.

9. A container assembly, comprising the bracket mount of claim 1 in combination with a bin and a cover,
the bin having an open end, a front side and a back side, the back side including a structure for releasably engaging the bin plate;
the cover configured to matingly engage the cover stilt and vertical support plate.

10. The container assembly of claim 9, wherein the back side of the bin enclosure of the container comprises a female mount component for releasably engaging a male mount component on the bin plate.

11. The container assembly of claim 9 wherein,
when the bin plate with the bin attached thereto is positioned proximal to the vertical support plate, the cover is pivotal to cover and uncover the open end of the bin, and
when the bin plate with the bin attached thereto is pivoted outwardly from the vertical support plate, the cover stilt is pivotable outwardly from the vertical support plate to support the cover in an open position relative to the bin.

12. A method of emptying a product disposal bin containing a cover comprising the steps of:
pivoting the cover upward from the bin to an open position;
pivoting a bin having an open end outwardly, relative to a vertical structure, from a vertical support plate;
pivoting a cover stilt outward, relative to the vertical structure, from the vertical support plate;
supporting the cover in the open position using the cover stilt;
exposing the open end of the bin; and
removing the contents of the bin.

13. The method of claim 12 further comprising
pivoting the cover stilt inward relative to the vertical support structure;
pivoting the bin inward, relative to the vertical support structure;
engaging the bin with the vertical support structure;
pivoting the cover downward from the open position to at least partial cover the open end of the bin.

14. The method of claim 12 which includes first unlocking the bin and the cover.

15. The method of claim 12 which further includes removing and installing a liner from the bin.

16. The method of claim 12 wherein the pivoting of the cover stilt occurs automatically upon the pivoting of the cover.

17. The method of claim 12 which further includes sliding the bin off of the bin support plate to remove the bin and sliding a new bin on the bin support plate.

18. The method of claim 12 which further includes disengaging the cover from the vertical support structure to remove the cover and pivotally securing a new cover to the vertical support structure.
